(19) United States
(12) Patent Application Publication
(10) Pub. No.: US 2025/0269827 A1
(43) Pub. Date: Aug. 28, 2025

(54) VEHICLE INTEGRATED JACKING DEVICE

(71) Applicant: Tyrone Verser, Sr., Grand Prairie, TX (US)

(72) Inventor: Tyrone Verser, Sr., Grand Prairie, TX (US)

(21) Appl. No.: 18/588,559

(22) Filed: Feb. 27, 2024

(51) Int. Cl. B60S 9/12; B60S 9/22

(52) U.S. Cl. CPC B60S 9/12; B60S 9/22

(57) ABSTRACT

A vehicle integrated jacking device includes a vehicle that has an undercarriage and a plurality of wheels. A plurality of hydraulic jacks is each of the plurality of hydraulic jacks is removably attachable to the undercarriage of the vehicle. Each of the plurality of hydraulic jacks is independently actuatable into a retracted condition thereby facilitating the vehicle to be driven. Each of the plurality of hydraulic jacks is independently actuatable into an extended condition for lifting one or more of the plurality of wheels from the support surface for servicing the one or more of the wheels. A control panel is positioned within a cabin of the vehicle thereby facilitating each of the plurality of hydraulic jacks to be independently actuated into the extended condition or the retracted condition.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to jacking devices and more particularly pertains to a new jacking device for automatically lifting one or more wheels of a vehicle from a support surface.

### (2) Description of Related Art Including Information Disclosed Under 37 CFR 1.97 and 1.98

The prior art relates to jacking devices a variety of vehicle integrated jacking devices that each at least includes a plurality of jacks that are mounted to an undercarriage of a vehicle and a hydraulic pump that is in fluid communication with each of the plurality of jacks for jacking one or more wheels of the vehicle. In no instance does the prior art disclose a vehicle integrated jacking device that includes a plurality of jacks that are mounted to an undercarriage of a vehicle and a plurality of hydraulic pumps each associated with a respective jack for jacking one or more wheels of the vehicle.

### BRIEF SUMMARY OF THE INVENTION

An embodiment of the disclosure meets the needs presented above by generally comprising a vehicle that has an undercarriage and a plurality of wheels. A plurality of hydraulic jacks is each of the plurality of hydraulic jacks is removably attachable to the undercarriage of the vehicle. Each of the plurality of hydraulic jacks is independently actuatable into a retracted condition thereby facilitating the vehicle to be driven. Each of the plurality of hydraulic jacks is independently actuatable into an extended condition for lifting one or more of the plurality of wheels from the support surface for servicing the one or more of the wheels. A control panel is positioned within a cabin of the vehicle thereby facilitating each of the plurality of hydraulic jacks to be independently actuated into the extended condition or the retracted condition.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top phantom view of a vehicle integrated jacking device according to an embodiment of the disclosure.

FIG. 2 is a front view of a hydraulic jack of an embodiment of the disclosure.

FIG. 3 is a right side view of a hydraulic jack of an embodiment of the disclosure.

FIG. 4 is a left side view of a hydraulic jack of an embodiment of the disclosure.

FIG. 5 is a top perspective view of a hydraulic jack of an embodiment of the disclosure.

FIG. 6 is a phantom perspective in-use view of an embodiment of the disclosure.

### DETAILED DESCRIPTION OF THE INVENTION

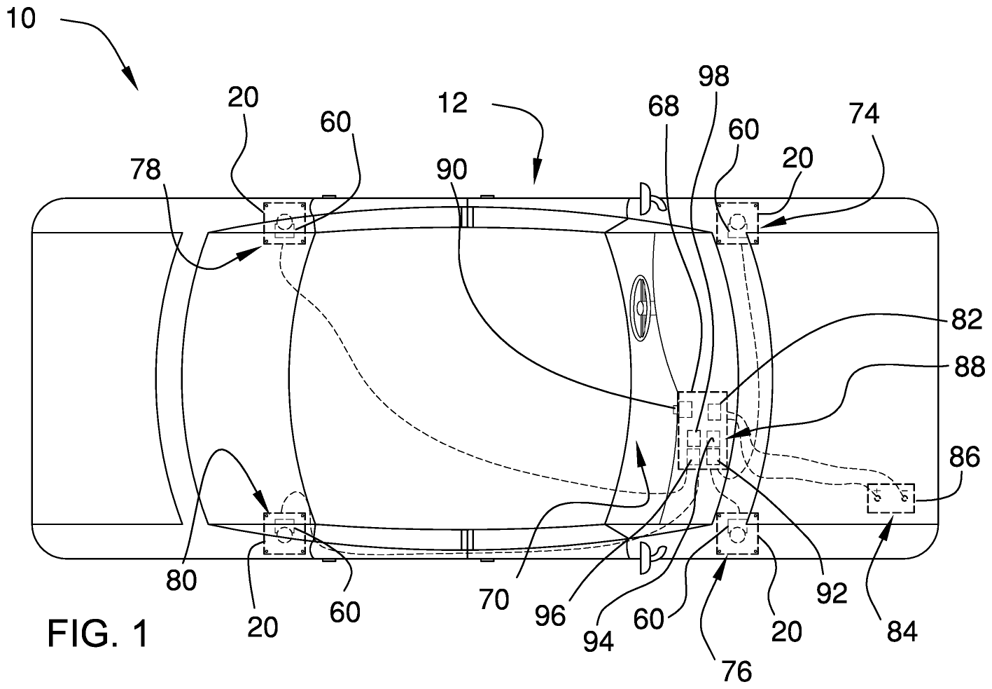

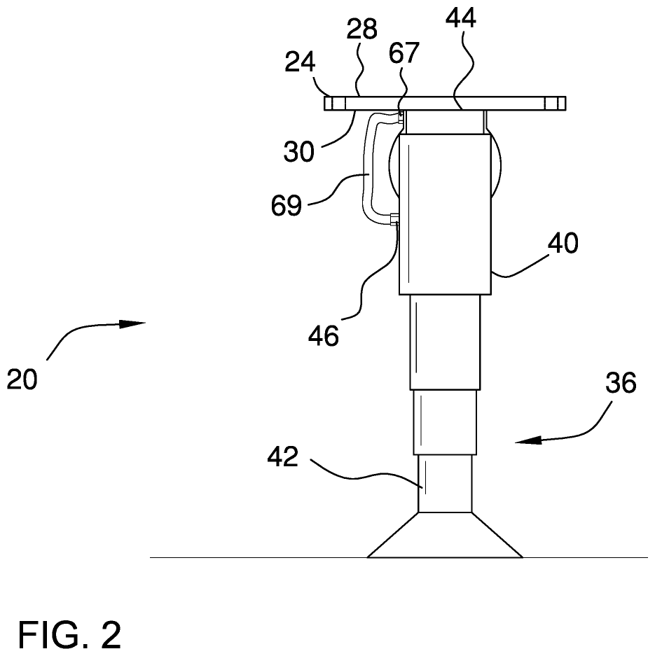

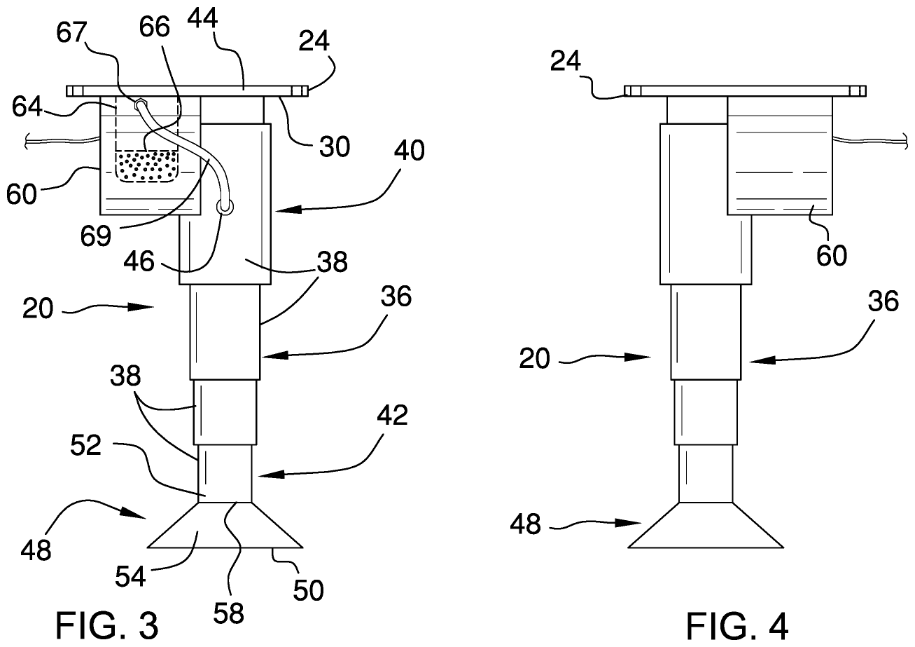

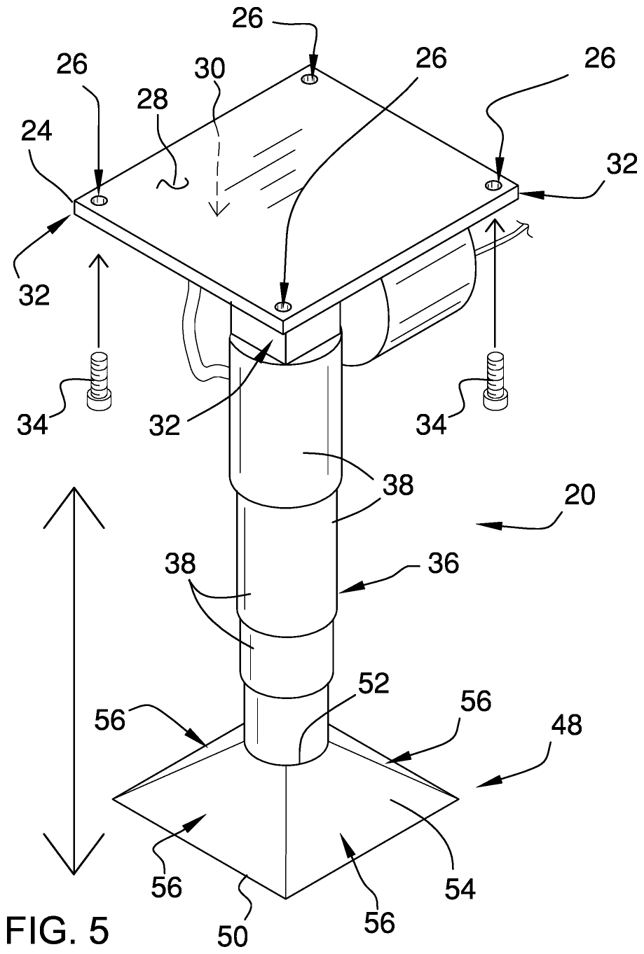

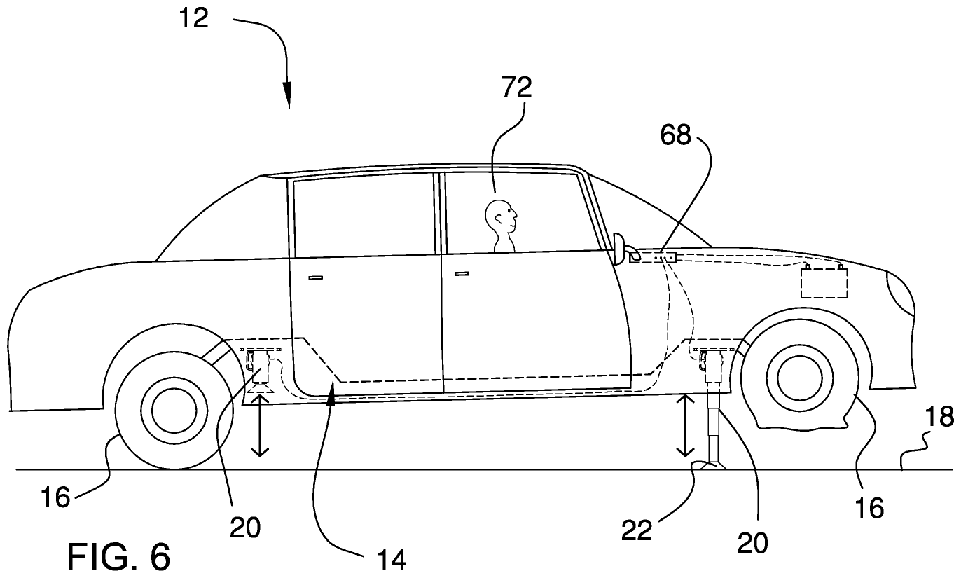

With reference now to the drawings, and in particular to FIGS. 1 through 6 thereof, a new jacking device embodying the principles and concepts of an embodiment of the disclosure and generally designated by the reference numeral 10 will be described.

As best illustrated in FIGS. 1 through 6, the vehicle integrated jacking device 10 generally comprises a vehicle 12 has an undercarriage 14 and a plurality of wheels 16 each located at a respective one of four corners 18 of the vehicle 12 such that each of the wheels 16 rolls along a support surface 18 when the vehicle 12 is driven. The vehicle 12 may comprise a passenger vehicle, a cargo vehicle or any other type of motorized vehicle that is driven on public roadways. Furthermore, the vehicle 12 may comprise a motorized vehicle that is intended to be driven off road, such as an all-terrain vehicle for example. A plurality of hydraulic jacks 20 is each removably attachable to the undercarriage 14 of the vehicle 12 and each of the plurality of hydraulic jacks 20 is positioned adjacent to a respective one of the plurality of wheels 16. Furthermore, each of the plurality of hydraulic jacks 20 has a foot 22 and each of the plurality of hydraulic jacks 20 is independently actuatable into a retracted condition such that the foot 22 of each of the plurality of hydraulic jacks 20 is positioned adjacent to the undercarriage 14 thereby facilitating the vehicle 12 to be driven. Conversely, each of the plurality of hydraulic jacks 20 is independently actuatable into an extended condition such that the foot 22 of one or more of the hydraulic jacks 20 abuts the support surface 18 thereby lifting one or more of the plurality of wheels 16 from the support surface 18 thereby facilitating one or more of the wheels 16 to be serviced.

Each of the plurality of hydraulic jacks 20 comprises a mounting plate 24 that has a plurality of fastener holes 26 each extending through a top surface 28 and a bottom surface 30 of the mounting plate 24. Each of the plurality of fastener holes 26 is aligned with a respective one of four corners 32 of the mounting plate 24. The bottom surface 30 of the mounting plate 24 abuts the undercarriage 14 of the vehicle 12 thereby facilitating a plurality of fasteners 34 to each be extended through a respective one of the plurality of fastener holes 26 and engage the undercarriage 14 for mounting the mounting plate 24 to the undercarriage 14. Each of the plurality of fasteners 34 may comprise a nut and a bolt or a screw or any other type of mechanical fastener that is commonly employed for fastening mechanical components together in a resilient fashion.

Each of the plurality of hydraulic jacks 20 includes a hydraulic cylinder 36 which comprises a plurality of nested cylinders 38 such that the hydraulic cylinder 36 has a telescopically adjustable length. The plurality of nested cylinders 38 includes a top cylinder 40 and a bottom cylinder 42 and an upper end 44 of the top cylinder 40 is attached to the bottom surface 30 of the mounting plate 24. The plurality of nested cylinders 38 is nested within each other when the hydraulic cylinder 36 is in a retracted condition such that the hydraulic cylinder 36 has a length that is less than a distance between the undercarriage 14 and the support surface 18. Conversely, each of the plurality of nested cylinders 38 extends outwardly from a respective one of the plurality of nested cylinders 38 when the hydraulic cylinder 36 is in an extended condition such that the hydraulic cylinder 36 has a length that is greater than the distance between the undercarriage 14 and the support surface 18. The hydraulic cylinder 36 is centrally located on the mounting plate 24 and the hydraulic cylinder 36 has a fluid port 46 that is integrated into the top cylinder 40.

Each of the plurality of hydraulic jacks 20 includes a base 48 that has a lower wall 50 and an upper wall 52 and an outer wall 54 extending between the lower wall 50 and the upper wall 52. The outer wall 54 has a plurality of intersecting sides 56 which are perpendicularly oriented with each other such that the base 48 has a polygonal shape. Furthermore, each of the plurality of intersecting sides 56 slopes inwardly between the lower wall 50 and the upper wall 52 such that base 48 of each of the plurality of hydraulic jacks 20 has the shape of a trapezoidal prism. In this way the base 48 of each of the plurality of hydraulic jacks 20 can evenly distribute the weight of the vehicle 12 on the support surface 18 thereby inhibiting the support surface 18 from being compressed by the weight of the vehicle 12. A lower end 58 of the bottom cylinder 42 of the hydraulic cylinder 36 is attached to the upper wall 52 such that the lower wall 50 of the base 48 defines the foot 22 of a respective one of the plurality of hydraulic jacks 20. Furthermore, the lower wall 50 is spaced upwardly from the support surface 18 when the hydraulic cylinder 36 is in the retracted condition and the lower wall 50 rests on the support surface 18 when the hydraulic cylinder 36 is in the extended condition.

Each of the hydraulic jacks 20 includes a hydraulic pump 60 that is attached to the bottom surface 30 of the mounting plate 24 and the hydraulic pump 60 is positioned between a perimeter edge 62 of the mounting plate 24 and the hydraulic cylinder 36. The hydraulic pump 60 includes a reservoir 64 which contains a hydraulic fluid 66 and the hydraulic pump 60 has a fluid port 67. The hydraulic pump 60 may comprise an electrically operated hydraulic pump of any conventional design that has a sufficient output pressure to facilitate the hydraulic cylinder 36 to lift at least 900.0 kg. Each of the hydraulic jacks 20 includes a fluid hose 69 that is fluidly coupled between the fluid port 67 on the hydraulic pump 60 and the fluid port 46 on the hydraulic cylinder 36. The hydraulic pump 60 urges the hydraulic fluid 66 into the hydraulic cylinder 36 when the hydraulic pump 60 is actuated into a first condition thereby facilitating the hydraulic cylinder 36 to be urged into the extended condition. Conversely, the hydraulic pump 60 urges the hydraulic fluid 66 outwardly from the hydraulic pump 60 when the hydraulic pump 60 is actuated into a second condition thereby facilitating the hydraulic cylinder 36 to be urged into the retracted condition.

A control panel 68 is provided and the control panel 68 is positioned within a cabin 70 of the vehicle 12 such that the control panel 68 is accessible to a driver 72 of the vehicle 12. The control panel 68 is in communication with each of the plurality of hydraulic jacks 20 thereby facilitating each of the plurality of hydraulic jacks 20 to be independently actuated into the extended condition or the retracted condition. Additionally, the plurality of hydraulic jacks 20 includes a first hydraulic jack 74 and a second hydraulic jack 76 and a third hydraulic jack 78 and a fourth hydraulic jack 80. The control panel 68 comprises a processor 82 that is positioned within the control panel 68. The processor 82 is electrically coupled to a power source 84 comprising an electrical system 86 of the vehicle 12 and the processor 82 is in electrical communication with the hydraulic pump 60 of each of the plurality of hydraulic jacks 20. Furthermore, the processor 82 receives a first lift input and a first lower input and a second lift input and a second lower input and a third lift input and a third lower input and a fourth lift input and a fourth lower input.

The control panel 68 includes a plurality of pump controllers 88 and each of the plurality of pump controllers 88 is integrated into the control panel 68. Additionally, each of the plurality of pump controllers 88 is electrically coupled to the processor 82. The control panel 68 includes a driver interface 90 that is integrated into the control panel 68 such that the driver interface 90 can be manipulated by the driver 72 of the vehicle 12. The driver interface 90 is electrically coupled to the processor 82 and the driver interface 90 facilitates independent control of the hydraulic pump 60 of each of the plurality of hydraulic jacks 20 with respect to actuating the hydraulic pump 60 of each of the plurality of hydraulic jacks 20 in the first condition or the second condition. Furthermore, the driver interface 90 may comprise a touch screen that displays icons which are associated with each of the plurality of hydraulic jacks 20 or other type of electronic control which facilitates the driver 72 to independently control each of the plurality of hydraulic jacks 20.

The processor 82 receives the first lift input when the driver interface 90 is manipulated to actuate the hydraulic pump 60 of the first hydraulic jack 74 into the first condition and the processor 82 receives the first lower input when the driver interface 90 is manipulated to actuate the hydraulic pump 60 of the first hydraulic jack 74 into the second condition. The processor 82 receives the second lift input when the driver interface 90 is manipulated to actuate the hydraulic pump 60 of the second hydraulic jack 76 into the first condition and the processor 82 receives the second lower input when the driver interface 90 is manipulated to actuate the hydraulic pump 60 of the second hydraulic jack 76 into the second condition. The processor 82 receives the third lift input when the driver interface 90 is manipulated to actuate the hydraulic pump 60 of the third hydraulic jack 78 into the first condition and the processor 82 receives the third lower input when the driver interface 90 is manipulated to actuate the hydraulic pump 60 of the third hydraulic jack 78 into the second condition. Finally, the processor 82 receives the fourth lift input when the driver interface 90 is manipulated to actuate the hydraulic pump 60 of the fourth hydraulic jack 80 into the first condition and the processor 82 receives the fourth lower input when the driver interface 90 is manipulated to actuate the hydraulic pump 60 of the fourth hydraulic jack 80 into the second condition.

The plurality of pump controllers 88 includes a first pump controller 92 and a second pump controller 94 and a third pump controller 96 and a fourth pump controller 98. The first pump controller 92 is electrically coupled to the hydraulic pump 60 of the first hydraulic jack 74 and the second pump controller 94 is electrically coupled to the hydraulic pump 60 of the second hydraulic jack 76. The third pump controller 96 is electrically coupled to the hydraulic pump 60 of the third hydraulic jack 78 and the fourth pump controller 98 is electrically coupled to the hydraulic pump 60 of the fourth hydraulic jack 80. Each of the plurality of pump controllers 88 may comprise a solid state control that is commonly associated with electronic hydraulic pump 60 controls.

The hydraulic pump 60 of the first hydraulic jack 74 is actuated into the first condition when the first pump controller 92 receives the first lift input from the processor 82 and the hydraulic pump 60 of the first hydraulic jack 74 is actuated into the second condition when the first pump controller 92 receives the first lower input from the processor 82. The hydraulic pump 60 of the second hydraulic jack 76 is actuated into the first condition when the second pump controller 94 receives the second lift input from the processor 82 and the hydraulic pump 60 of the second hydraulic jack 76 is actuated into the second condition when the second pump controller 94 receives the second lower input from the processor 82. The hydraulic pump 60 of the third hydraulic jack 78 is actuated into the first condition when the third pump controller 96 receives the third lift input from the processor 82 and the hydraulic pump 60 of the third hydraulic jack 78 is actuated into the second condition when the third pump controller 96 receives the third lower input from the processor 82. The hydraulic pump 60 of the fourth hydraulic jack 80 is actuated into the first condition when the fourth pump controller 98 receives the fourth lift input from the processor 82 and the hydraulic pump 60 of the fourth hydraulic jack 80 is actuated into the second condition when the fourth pump controller 98 receives the fourth lower input from the processor 82.

In use, the driver 72 manipulates the driver interface 90 to actuate one or more of the hydraulic jacks 20 into extended condition when the driver 72 needs to lift one or more of the wheels 16 of the vehicle 12 upwardly from the support surface 18. In this way the driver 72 can service the wheel 16 that is lifted from the support surface 18 when the wheel 16 that is lifted from the support surface 18 has become damaged, for example, or when the wheel 16 that is lifted from the support surface 18 needs to be changed. In this way the driver 72 does not have to employ a conventional jack to lift the vehicle 12 when the driver 72 needs to perform service on the vehicle 12. In this way an individual of limited mechanical skill or an individual of limited physical capability can easily lift one or more of the wheels 16 of the vehicle 12 from the support surface 18. The driver 72 manipulates the driver interface 90 to actuate one or more of the hydraulic jacks 20 into the retracted condition when the driver 72 has completed performing the service work thereby facilitating the vehicle 12 to be driven normally.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle integrated jacking device for automatically lifting one of more tires of a vehicle from a support surface for servicing the vehicle, said device comprising:
a vehicle having an undercarriage and a plurality of wheels each being located at a respective one of four corners of said vehicle such that each of said wheels rolls along a support surface when said vehicle is driven;
a plurality of hydraulic jacks, each of said plurality of hydraulic jacks being removably attachable to said undercarriage of said vehicle, each of said plurality of hydraulic jacks being positioned adjacent to a respective one of said plurality of wheels, each of said plurality of hydraulic jacks having a foot, each of said plurality of hydraulic jacks being independently actuatable into a retracted condition such that said foot of each of said plurality of hydraulic jacks is positioned adjacent to said undercarriage thereby facilitating said vehicle to be driven, each of said plurality of hydraulic jacks being independently actuatable into an extended condition such that said foot of one or more of said hydraulic jacks abuts the support surface thereby lifting one or more of said plurality of wheels from the support surface thereby facilitating one or more of said wheels to be serviced; and
a control panel being positioned within a cabin of said vehicle wherein said control panel is configured to be accessible to a driver of said vehicle, said control panel being in communication with each of said plurality of hydraulic jacks thereby facilitating each of said plurality of hydraulic jacks to be independently actuated into said extended condition or said retracted condition, said control panel including a plurality of discrete control circuits each being assigned to a respective one of said plurality of hydraulic jacks.

2. The device according to claim 1, wherein:
each of said plurality of hydraulic jacks comprises a mounting plate having a plurality of fastener holes each extending through a top surface and a bottom surface of said mounting plate;
each of said plurality of fastener holes is aligned with a respective one of four corners of said mounting plate;
said bottom surface of said mounting plate abuts said undercarriage of said vehicle thereby facilitating a plurality of fasteners to each be extended through a respective one of said plurality of fastener holes and engage said undercarriage for mounting said mounting plate to said undercarriage;
each of said plurality of hydraulic jacks comprises a hydraulic cylinder comprising a plurality of nested cylinders such that said hydraulic cylinder has a telescopically adjustable length;
said plurality of nested cylinders includes a top cylinder and a bottom cylinder;
an upper end of said top cylinder is attached to said bottom surface of said mounting plate;
said plurality of nested cylinders is nested within each other when said hydraulic cylinder is in a retracted condition such that said hydraulic cylinder has a length that is less than a distance between said undercarriage and the support surface;
each of said plurality of nested cylinders extends outwardly from a respective one of said plurality of nested cylinders when said hydraulic cylinder is in an extended condition such that said hydraulic cylinder has a length that is greater than said distance between said undercarriage and the support surface;
said hydraulic cylinder is centrally located on said mounting plate; and
said hydraulic cylinder has a fluid port being integrated into said top cylinder.

3. The device according to claim 2, wherein:
each of said plurality of hydraulic jacks includes a base having a lower wall and an upper wall and an outer wall extending between said lower wall and said upper wall;
said outer wall has a plurality of intersecting sides being perpendicularly oriented with each other such that said base has a polygonal shape;
each of said plurality of intersecting sides slopes inwardly between said lower wall and said upper wall such that base of each of said plurality of hydraulic jacks has the shape of a trapezoidal prism wherein said base of each of said plurality of hydraulic jacks is configured to evenly distribute the weight of said vehicle on the support surface thereby inhibiting the support surface from being compressed by the weight of said vehicle;
a lower end of said bottom cylinder of said hydraulic cylinder is attached to said upper wall such that said lower wall of said base defines said foot of a respective one of said plurality of jacks; and
said lower wall being spaced upwardly from the support surface when said hydraulic cylinder is in said retracted condition, said lower wall resting on the support surface when said hydraulic cylinder is in said extended condition.

4. The device according to claim 2, wherein:
each of said plurality of hydraulic jacks includes a hydraulic pump being attached to said bottom surface of said mounting plate;
said hydraulic pump is positioned between a perimeter edge of said mounting plate and said hydraulic cylinder;
said hydraulic pump includes a reservoir containing a hydraulic fluid;
said hydraulic pump has a fluid port;
each of said plurality of hydraulic jacks includes a fluid hose being fluidly coupled between said fluid port on said hydraulic pump and said fluid port on said hydraulic cylinder;
said hydraulic pump urges said hydraulic fluid into said hydraulic cylinder when said hydraulic pump is actuated into a first condition thereby facilitating said hydraulic cylinder to be urged into said extended condition; and
said hydraulic pump urges said hydraulic fluid outwardly from said hydraulic pump when said hydraulic pump is actuated into a second condition thereby facilitating said hydraulic cylinder to be urged into said retracted condition.

5. The device according to claim 1, wherein:
each of said plurality of hydraulic jacks includes a hydraulic pump;
said control panel comprises a processor being positioned within said control panel;
said processor is electrically coupled to a power source comprising an electrical system of said vehicle;
said processor is in electrical communication with said hydraulic pump of each of said plurality of hydraulic jacks;
said processor receives a first lift input and a first lower input and a second lift input and a second lower input and a third lift input and a third lower input and a fourth lift input and a fourth lower input;
said control panel comprises a plurality of pump controllers;
each of said plurality of pump controllers is integrated into said control panel; and
each of said plurality of pump controllers is electrically coupled to said processor.

6. The device according to claim 5, wherein:
said plurality of hydraulic jacks includes a first hydraulic jack and a second hydraulic jack and a third hydraulic jack and a fourth hydraulic jack;
said control panel includes a driver interface being integrated into said control panel wherein said driver interface is configured to be manipulated by the driver of said vehicle; and
said driver interface is electrically coupled to said processor; and
said driver interface facilitates independent control of said hydraulic pump of each of said plurality of hydraulic jacks with respect to actuating said hydraulic pump of each of said plurality of hydraulic jacks in a first condition or a second condition.

7. The device according to claim 6, wherein:
said processor receives said first lift input when said driver interface is manipulated to actuate said hydraulic pump of said first hydraulic jack into said first condition; and
said processor receives said first lower input when said driver interface is manipulated to actuate said hydraulic pump of said first hydraulic jack into said second condition.

8. The device according to claim 6, wherein:
said processor receives said second lift input when said driver interface is manipulated to actuate said hydraulic pump of said second hydraulic jack into said first condition; and
said processor receives said second lower input when said driver interface is manipulated to actuate said hydraulic pump of said second hydraulic jack into said second condition.

9. The device according to claim 6, wherein:
said processor receives said third lift input when said driver interface is manipulated to actuate said hydraulic pump of said third hydraulic jack into said first condition; and
said processor receives said third lower input when said driver interface is manipulated to actuate said hydraulic pump of said third hydraulic jack into said second condition.

10. The device according to claim 6, wherein:
said processor receives said fourth lift input when said driver interface is manipulated to actuate said hydraulic pump of said fourth hydraulic jack into said first condition; and
said processor receives said fourth lower input when said driver interface is manipulated to actuate said hydraulic pump of said fourth hydraulic jack into said second condition.

11. The device according to claim 5, wherein:
said plurality of hydraulic jacks includes a first hydraulic jack and a second hydraulic jack and a third hydraulic jack and a fourth hydraulic jack;
said plurality of pump controllers includes a first pump controller and a second pump controller and a third pump controller and a fourth pump controller;
wherein said first pump controller is electrically coupled to said hydraulic pump of said first hydraulic jack;
wherein said second pump controller is electrically coupled to said hydraulic pump of said second hydraulic jack;
wherein said third pump controller is electrically coupled to said hydraulic pump of said third hydraulic jack; and
wherein said fourth pump controller is electrically coupled to said hydraulic pump of said fourth hydraulic jack.

12. The device according to claim 11, wherein:
said hydraulic pump of said first hydraulic jack is actuated into said first condition when said first pump controller receives said first lift input from said processor; and
wherein said hydraulic pump of said first hydraulic jack is actuated into said second condition when said first pump controller receives said first lower input from said processor.

13. The device according to claim 11, wherein:
wherein said hydraulic pump of said second hydraulic jack is actuated into said first condition when said second pump controller receives said second lift input from said processor; and
wherein said hydraulic pump of said second hydraulic jack is actuated into said second condition when said second pump controller receives said second lower input from said processor.

14. The device according to claim 11, wherein:
wherein said hydraulic pump of said third hydraulic jack is actuated into said first condition when said third pump controller receives said third lift input from said processor; and
wherein said hydraulic pump of said third hydraulic jack is actuated into said second condition when said third pump controller receives said third lower input from said processor.

15. The device according to claim 11, wherein:
said hydraulic pump of said fourth hydraulic jack is actuated into said first condition when said fourth pump controller receives said fourth lift input from said processor; and
wherein said hydraulic pump of said fourth hydraulic jack is actuated into said second condition when said fourth pump controller receives said fourth lower input from said processor.

16. A vehicle integrated jacking device for automatically lifting one of more tires of a vehicle from a support surface for servicing the vehicle, said device comprising:
a vehicle having an undercarriage and a plurality of wheels each being located at a respective one of four corners of said vehicle such that each of said wheels rolls along a support surface when said vehicle is driven;
a plurality of hydraulic jacks, each of said plurality of hydraulic jacks being removably attachable to said undercarriage of said vehicle, each of said plurality of hydraulic jacks being positioned adjacent to a respective one of said plurality of wheels, each of said plurality of hydraulic jacks having a foot, each of said plurality of hydraulic jacks being independently actuatable into a retracted condition such that said foot of each of said plurality of hydraulic jacks is positioned adjacent to said undercarriage thereby facilitating said vehicle to be driven, each of said plurality of hydraulic jacks being independently actuatable into an extended condition such that said foot of one or more of said hydraulic jacks abuts the support surface thereby lifting one or more of said plurality of wheels from the support surface thereby facilitating one or more of said wheels to be serviced, each of said plurality of hydraulic jacks comprising:
a mounting plate having a plurality of fastener holes each extending through a top surface and a bottom surface of said mounting plate, each of said plurality of fastener holes being aligned with a respective one of four corners of said mounting plate, said bottom surface of said mounting plate abutting said undercarriage of said vehicle thereby facilitating a plurality of fasteners to each be extended through a respective one of said plurality of fastener holes and engage said undercarriage for mounting said mounting plate to said undercarriage;
a hydraulic cylinder comprising a plurality of nested cylinders such that said hydraulic cylinder has a telescopically adjustable length, said plurality of nested cylinders including a top cylinder and a bottom cylinder, an upper end of said top cylinder being attached to said bottom surface of said mounting plate, said plurality of nested cylinders being nested within each other when said hydraulic cylinder is in a retracted condition such that said hydraulic cylinder has a length that is less than a distance between said undercarriage and the support surface, each of said plurality of nested cylinders extending outwardly from a respective one of said plurality of nested cylinders when said hydraulic cylinder is in an extended condition such that said hydraulic cylinder has a length that is greater than said distance between said undercarriage and the support surface, said hydraulic cylinder being centrally located on said mounting plate, said hydraulic cylinder having a fluid port being integrated into said top cylinder;
a base having a lower wall and an upper wall and an outer wall extending between said lower wall and said upper wall, said outer wall having a plurality of intersecting sides being perpendicularly oriented with each other such that said base has a polygonal shape, each of said plurality of intersecting sides sloping inwardly between said lower wall and said upper wall such that base of each of said plurality of hydraulic jacks has the shape of a trapezoidal prism wherein said base of each of said plurality of hydraulic jacks is configured to evenly distribute the weight of said vehicle on the support surface thereby inhibiting the support surface from being compressed by the weight of said vehicle, a lower end of said bottom cylinder of said hydraulic cylinder being attached to said upper wall such that said lower wall of said base defines said foot of a respective one of said plurality of hydraulic jacks, said lower wall being spaced upwardly from the support surface when said hydraulic cylinder is in said retracted condition, said lower wall resting on the support surface when said hydraulic cylinder is in said extended condition;
a hydraulic pump being attached to said bottom surface of said mounting plate, said hydraulic pump being positioned between a perimeter edge of said mounting plate and said hydraulic cylinder, said hydraulic pump including a reservoir containing a hydraulic fluid, said hydraulic pump having a fluid port; and
a fluid hose being fluidly coupled between said fluid port on said hydraulic pump and said fluid port on said hydraulic cylinder, said hydraulic pump urging said hydraulic fluid into said hydraulic cylinder when said hydraulic pump is actuated into a first condition thereby facilitating said hydraulic cylinder to be urged into said extended condition, said hydraulic pump urging said hydraulic fluid outwardly from said hydraulic pump when said hydraulic pump is actuated into a second condition thereby facilitating said hydraulic cylinder to be urged into said retracted condition; and
a control panel being positioned within a cabin of said vehicle wherein said control panel is configured to be accessible to a driver of said vehicle, said control panel being in communication with each of said plurality of hydraulic jacks thereby facilitating each of said plurality of hydraulic jacks to be independently actuated into said extended condition or said retracted condition;
wherein said plurality of hydraulic jacks includes a first hydraulic jack and a second hydraulic jack and a third hydraulic jack and a fourth hydraulic jack;
said control panel comprising:
a processor being positioned within said control panel, said processor being electrically coupled to a power source comprising an electrical system of said vehicle, said processor being in electrical communication with said hydraulic pump of each of said plurality of hydraulic jacks, said processor receiving a first lift input and a first lower input and a second lift input and a second lower input and a third lift input and a third lower input and a fourth lift input and a fourth lower input;
a plurality of pump controllers, each of said plurality of pump controllers being integrated into said control panel, each of said plurality of pump controllers being electrically coupled to said processor; and
a driver interface being integrated into said control panel wherein said driver interface is configured to be manipulated by the driver of said vehicle, said driver interface being electrically coupled to said processor, said driver interface facilitating independent control of said hydraulic pump of each of said plurality of hydraulic jacks with respect to actuating said hydraulic pump of each of said plurality of hydraulic jacks in said first condition or said second condition, said processor receiving said first lift input when said driver interface is manipulated to actuate said hydraulic pump of said first hydraulic jack into said first condition, said processor receiving said first lower input when said driver interface is manipulated to actuate said hydraulic pump of said first hydraulic jack into said second condition, said processor receiving said second lift input when said driver interface is manipulated to actuate said hydraulic pump of said second hydraulic jack into said first condition, said processor receiving said second lower input when said driver interface is manipulated to actuate said hydraulic pump of said second hydraulic jack into said second condition, said processor receiving said third lift input when said driver interface is manipulated to actuate said hydraulic pump of said third hydraulic jack into said first condition, said processor receiving said third lower input when said driver interface is manipulated to actuate said hydraulic pump of said third hydraulic jack into said second condition, said processor receiving said fourth lift input when said driver interface is manipulated to actuate said hydraulic pump of said fourth hydraulic jack into said first condition, said processor receiving said fourth lower input when said driver interface is manipulated to actuate said hydraulic pump of said fourth hydraulic jack into said second condition;
wherein said plurality of pump controllers includes a first pump controller and a second pump controller and a third pump controller and a fourth pump controller;
wherein said first pump controller is electrically coupled to said hydraulic pump of said first hydraulic jack;
wherein said second pump controller is electrically coupled to said hydraulic pump of said second hydraulic jack;
wherein said third pump controller is electrically coupled to said hydraulic pump of said third hydraulic jack;
wherein said fourth pump controller is electrically coupled to said hydraulic pump of said fourth hydraulic jack;
wherein said hydraulic pump of said first hydraulic jack is actuated into said first condition when said first pump controller receives said first lift input from said processor;
wherein said hydraulic pump of said first hydraulic jack is actuated into said second condition when said first pump controller receives said first lower input from said processor;
wherein said hydraulic pump of said second hydraulic jack is actuated into said first condition when said second pump controller receives said second lift input from said processor;
wherein said hydraulic pump of said second hydraulic jack is actuated into said second condition when said second pump controller receives said second lower input from said processor;
wherein said hydraulic pump of said third hydraulic jack is actuated into said first condition when said third pump controller receives said third lift input from said processor;
wherein said hydraulic pump of said third hydraulic jack is actuated into said second condition when said third pump controller receives said third lower input from said processor;
wherein said hydraulic pump of said fourth hydraulic jack is actuated into said first condition when said fourth pump controller receives said fourth lift input from said processor; and
wherein said hydraulic pump of said fourth hydraulic jack is actuated into said second condition when said fourth pump controller receives said fourth lower input from said processor.
